(19) United States
(12) Patent Application Publication
(10) Pub. No.: US 2007/0156996 A1
(43) Pub. Date: Jul. 5, 2007

(54) Memory system with improved additive latency and method of controlling the same

(75) Inventor: Hoe-Ju Chung, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/646,553

(22) Filed: Dec. 28, 2006

(30) Foreign Application Priority Data
Jan. 4, 2006 (KR) 10-2006-0000771

(51) Int. Cl. G06F 13/28

(52) U.S. Cl. 711/167

(57) ABSTRACT

A memory system may include a memory device and a memory controller. The memory device may include a first bank and a second bank. The memory controller may include a read request scheduling queue that may store a read request, and may controls the read request scheduling queue so that if first and the second read requests to the first bank and a third read request to the second bank occur successively, data from the memory device may be output seamlessly by applying a first additive latency to first and second read requests to the first bank, and by applying a second additive latency to a third read request to the second bank.

### PRIORITY STATEMENT

This U.S. non-provisional application claims benefit of priority under 35 USC § 119 to Korean Patent Application No. 2006-771, filed on Jan. 4, 2006 in the Korean Intellectual Property Office (KIPO), the entire contents of which are herein incorporated by reference.

### BACKGROUND

1. Field

Example embodiments relate to a semiconductor device, for example, a memory system and a method of controlling the memory system capable of improving additive latency of synchronous dynamic random-access memory (SDRAM).

2. Description of the Related Art

Semiconductor memory devices are continuously being improved to achieve higher degrees of integration and higher speeds. Packet-type memory, for example, Rambus dynamic random-access memory (RDRAM) and double data rate (DDR) synchronous DRAM (SDRAM), has been developed that may increase operating speeds.

DDR SDRAM may input and/or output two data per clock synchronized with a rising edge and a falling edge of the clock. Therefore, the DDR SDRAM may have at least double the bandwidth of standard SDRAM, and thus may operate at higher speed without increasing the clock frequency.

DDR SDRAM may be capable of executing one command per clock in order to control the DDR SDRAM using a pipeline method. Therefore, if two commands collide with each other at one clock, the memory controller may control command scheduling by delaying one of the two commands by one clock with respect to the other command.

FIG. 1 is a timing diagram illustrating access operations of a conventional DDR SDRAM. Referring to FIG. 1, if a row-to-row delay (tRRD) corresponds to a two-clock interval, a column latency (CL) corresponds to a four-clock interval, and a burst length (BL) corresponds to a four-clock interval, an active command ACT3 and a read command READ1 may be input simultaneously at clock 5 (at T4) to collide with each other. Therefore, an ACT3 command may be one-clock delayed to be executed at clock 6 (at T5). Thus, data outputs D2 and D3 may not be successively output, and a one-clock bubble may exist between the data outputs D2 and D3. Accordingly, effective use of a bandwidth may be interrupted.

In order to solve this problem, posted CAS operation has been introduced for the DDR SDRAM. In the posted CAS operation, read/write commands may be input earlier than a predetermined timing of the DDR SDRAM, and the input read/write commands may be executed after a predetermined clock interval. For example, information about the timing interval in which read/write commands may be input earlier than a predetermined timing of the DDR SDRAM may be referred to as additive latency (AL). An AL may correspond to a clock interval from the time when read/write commands are input after a memory device is activated, and may be referred to as a row-to-column delay (tRCD).

FIG. 2 is a timing diagram illustrating a conventional posted CAS operation. Referring to FIG. 2, if an AL, a CL and a BL correspond to 3, 4, and 4, respectively, an ACT1 command may be input at clock 0 (at T0), and a READ1 command may be input at clock 1 (at T1). After a three-clock interval, the posted CAS operation may be executed at clock 4 (at T4), and thus the ACT3 command may be input at clock 4.Accordingly, data outputs D1, D2 and D3 may be output successively and seamlessly.

In a conventional technique that may be related to additive latency and posted CAS operation, an AL may be set in a mode register through a mode register set (MRS) command. Therefore, if the AL is set as a specified value, the fixed AL may be applied to all banks. Thus, to change the AL, an AL in the mode register may be changed by executing MRS operations in advance. However, the MRS operations may prevent higher-speed operation of the memory device.

### SUMMARY

Example embodiments may provide a memory system and a method of controlling a memory system that may reset an additive latency of a corresponding bank at every ACT command.

Example embodiments may provide a memory system for controlling a multi-bank memory device that may increase operation speed by eliminating MRS access time.

Example embodiments may provide a memory controller that may be adapted for the memory system.

Example embodiments may provide a memory device and a method of controlling a memory device that may be adapted for the memory system.

In an example embodiment, a memory system may include a memory device and a memory controller. The memory device may include at least a first bank and a second bank The memory controller may include a read request scheduling queue which may store a read request, and may control the read request scheduling queue so that if first and second read requests to the first bank and a third read request to the second bank occur successively, data from the memory device may be output seamlessly by applying a first additive latency to first and second read requests to the first bank and by applying a second additive latency to a third read request to the second bank.

According to an example embodiment, the first and the second additive latencies may be different from each other.

According to an example embodiment, the data may be maintained in an output sequence order according to a sequence order of a plurality of read requests to a same one of the at least first and second banks.

According to an example embodiment, the memory controller may be configured to determine if the first read request is going to collide with a second active command packet.

According to an example embodiment, if the first read request is going to collide with a second active command packet, the memory controller may be configured to transmit a first active command packet to the memory device to set the first additive latency.

According to an example embodiment, the memory controller may be configured to determine if there is an in-bank read request to the first bank.

According to an example embodiment, if there is an in-bank read request to the first bank, the memory controller may be configured to transmit a second active command packet to the memory device to set the second additive latency.

In an example embodiment, a memory device may include a packet managing unit, a multi-bank memory block, a sense-amplifying block, a bank decoder, a row decoder, a column address buffer, at least one additive latency block, a column decoder, a data output path block, a data input path block and a command decoder. The sense-amplifying block may sense-amplify input/output cell data. The bank decoder may select a bank of the multi-bank memory block in response to a bank address provided from the packet managing unit. The row decoder may select a wordline of the multi-bank memory block in response to a row address provided from the packet managing unit. The column address buffer may latch a column address provided from the packet managing unit. The additive latency block may delay the column address provided from the column address buffer by a clock interval in response to the additive latency code provided from the packet managing unit. The column decoder may select a column of the sense-amplifying block in response to a column address provided from the additive latency block. The data output path block may output read data provided from the sense-amplifying block to the packet managing unit. The data input path block may provide input data provided from the packet managing unit to the sense-amplifying block. The command decoder may generate control signals in response to a command provided from the packet managing unit.

According to an example embodiment, the at least one additive latency block may be a plurality of additive latency blocks. The plurality of additive latency blocks may be configured to input an additive latency code provided from the packet managing unit in response to a selection signal of the bank decoder.

In an example embodiment, a memory system may include a memory controller and a memory device. The memory controller may transmit an active command packet including an additive latency code and may transmit at least one of a read command packet and a write command packet. The memory device may receive the active command packet, reset an additive latency to the value specified by the additive latency code included in the active command packet, receive the at least one of the read command packet and write command packet, and execute the at least one of the read command packet and write command packet after a clock interval delay specified by the reset additive latency.

In an example embodiment, a method of controlling a memory system that may include a memory device having least a first bank and a second bank, and a memory controller having a read request scheduling queue that stores a read request, may include controlling the read request scheduling queue so that if a first read request and a second read request to the first bank and a third read request to the second bank occur successively, data from the memory device may be output seamlessly by applying a first additive latency to the first and second read requests to the first bank, and by applying a second additive latency to the third read request to the second bank.

According to an example embodiment, the first and the second additive latencies may be different from each other.

According to an example embodiment, the data may be maintained in an output sequence order according to a sequence order of a plurality of read requests to a same one of the at least first and second banks.

According to an example embodiment, it may be determined if the first read request is going to collide with a second active command packet.

According to an example embodiment, if the first read request is going to collide with a second active command packet, a first active command packet may be transmitted to the memory device to set the first additive latency.

According to an example embodiment, it may be determined if there is an in-bank read request to the first bank.

According to an example embodiment, if there is an in-bank read request to the first bank, a second active command packet may be transmitted to the memory device to set the second additive latency.

In an example embodiment, a method of controlling a multi-bank memory device may include transmitting an active command packet having an additive latency code to a memory device so that a corresponding bank of the memory device may have constant latency during an active state of the corresponding bank, transmitting a first read command packet to the memory device during a row-to-column delay of the memory device, transmitting a second read command packet to the memory device during the row-to-column delay of the memory device, and receiving first and second read data from the memory device in response to the first and the second read command packets.

In an example embodiment, a method of controlling a memory device may include inputting a first active command that activates a first bank and includes a first additive latency setting code to set an additive latency of the first bank in response to the first additive latency setting code, inputting a first read command with respect to the first bank, inputting a second read command with respect to the first bank, inputting a second active command that activates a second bank and includes a second additive latency setting code to set an additive latency of the second bank in response to the second additive latency setting code, executing the first read command in response to the set additive latency simultaneously with the inputting of the second active command, executing the second read command in response to the first set additive latency, inputting a third read command with respect to the second bank to execute the third read command in response to the first set additive latency, and outputting data according to an execution sequence of the first through the third read commands seamlessly.

In an example embodiment, a method of controlling a multi-bank memory device may include resetting an additive latency of each bank of the multi-bank memory device at every active period of each of the banks so that each of the banks may have constant additive latency during an active state of the corresponding bank.

According to an example embodiment, the additive latency of each of the banks may be reset by an additive latency code included in an active command packet.

According to an example embodiment, the reset additive latency may be equally applied to read commands that may be different from each other during the active period.

In an example embodiment, a recording medium storing program code for controlling a memory device may include a first program code segment that may cause an active command packet having an additive latency code to be transmitted to the memory device so that a corresponding bank has constant latency during an active state of the corresponding bank; a second program code segment that may cause a first read command packet to be transmitted to the memory device during a row-to-column delay of the memory device; a third program code segment that may cause a second read command packet to be transmitted to the memory device during the row-to-column delay of the memory device; and a fourth program code segment that may cause first and second read data to be read from the memory device in response to the first and the second read command packets.

### BRIEF DESCRIPTION OF THE DRAWINGS

Example embodiments will be described with reference to the accompanying drawings.

FIG. 1 is a timing diagram illustrating access operations of a conventional double data rate (DDR) synchronous dynamic random-access memory (SDRAM).

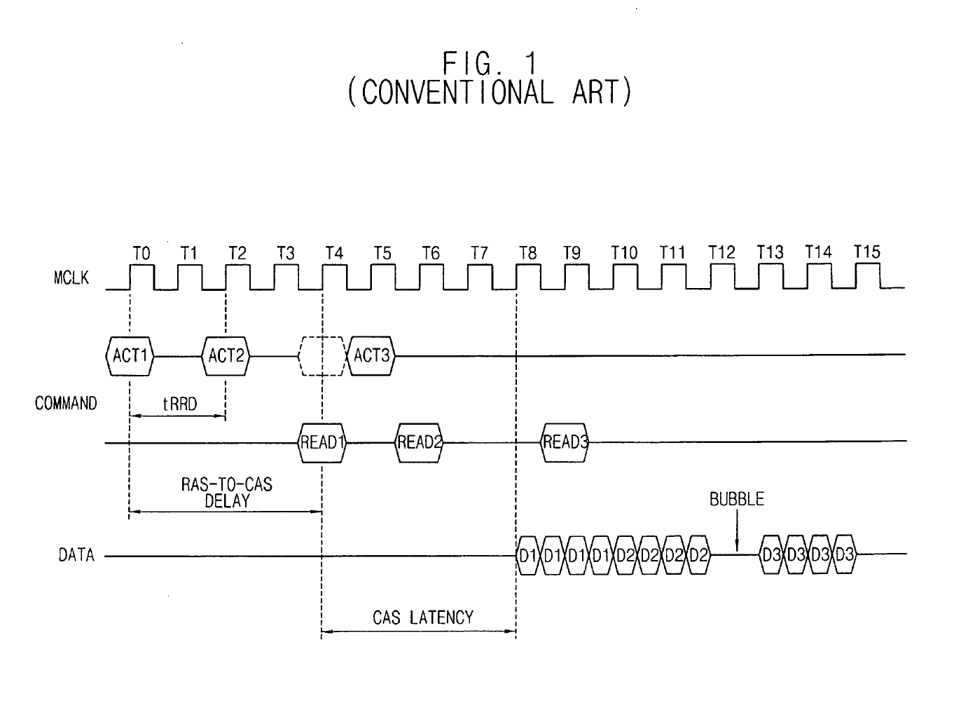

FIG. 2 is a timing diagram illustrating a conventional posted CAS operation.

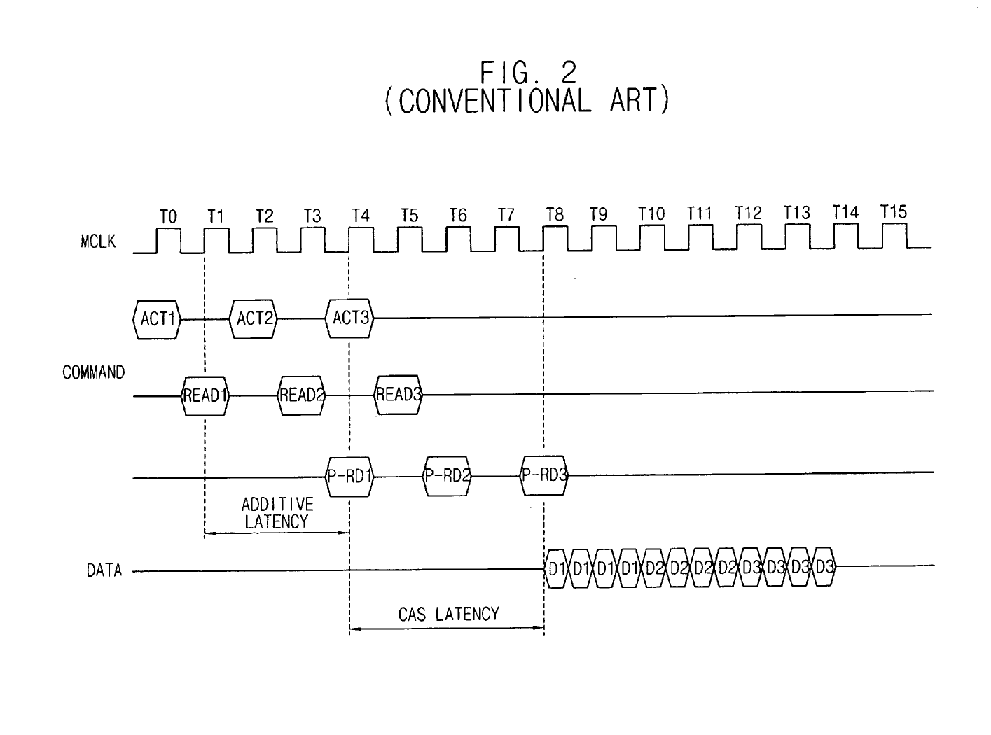

FIG. 3 is a block diagram illustrating a memory system according to an example embodiment of the present invention.

FIG. 4 is a diagram illustrating an example embodiment of a command/address (C/A) packet.

FIG. 5 is a flow chart illustrating the operation of a memory controller according to an example embodiment of the present invention.

FIG. 6 is a block diagram illustrating a memory device according to an example embodiment of the present invention.

FIG. 7 is a timing diagram illustrating the operation of the memory device shown in FIG. 6.

### DESCRIPTION OF EXAMPLE EMBODIMENTS

Example embodiments now will be described more fully with reference to the accompanying drawings. Example embodiments may, however, be embodied in many different forms and should not be construed as limited to the example embodiments set forth herein. Rather, these example embodiments are provided so that this disclosure will be thorough and complete, and will fully convey the scope to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments and is not intended to be limiting. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

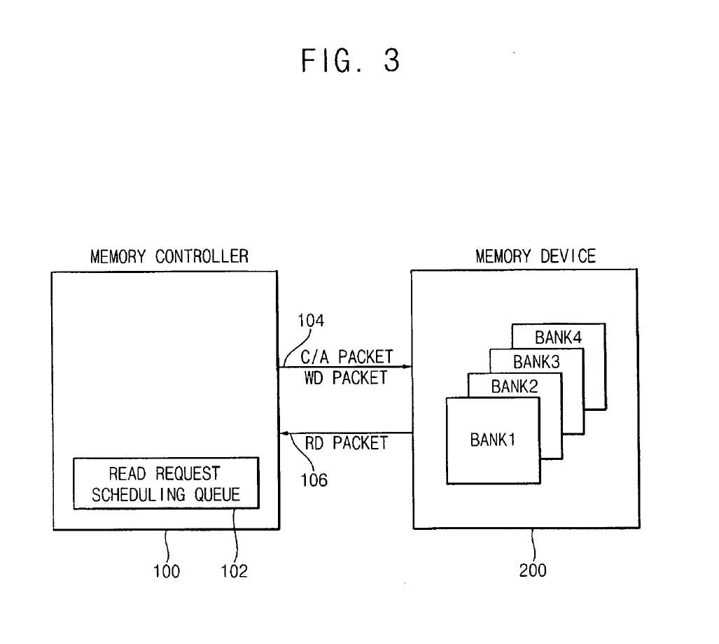

FIG. 3 is a block diagram illustrating a memory system according to an example embodiment of the present invention.

Referring to FIG. 3, a memory system may include a memory controller 100 and a memory device 200. The memory controller may include a read request scheduling queue 102. The memory controller 100 may transmit a read command to the memory device 200 in response to a read request from the read request scheduling queue 102. The memory controller 100 and the memory device 200 may exchange packet-type data with each other. The memory controller 100 may transmit a command/address (C/A) packet and/or a write data (WD) packet to the memory device 200 via a downloading bus 104. The memory device 200 may transmit a read data (RD) packet to the memory controller 100 via an uploading bus 106. The memory device 200 may be a multi-bank synchronous memory device and may include, for example, four banks.

If first and second read requests to first bank BANK1 and a third read request to second bank BANK2 occur successively, the memory controller 100 may control the read request scheduling queue 102 by applying a first additive latency to the first and the second read requests to the first bank BANK1 and by applying a second additive latency to the third read request to the second bank BANK2. The first and the second additive latencies may be different from each other.

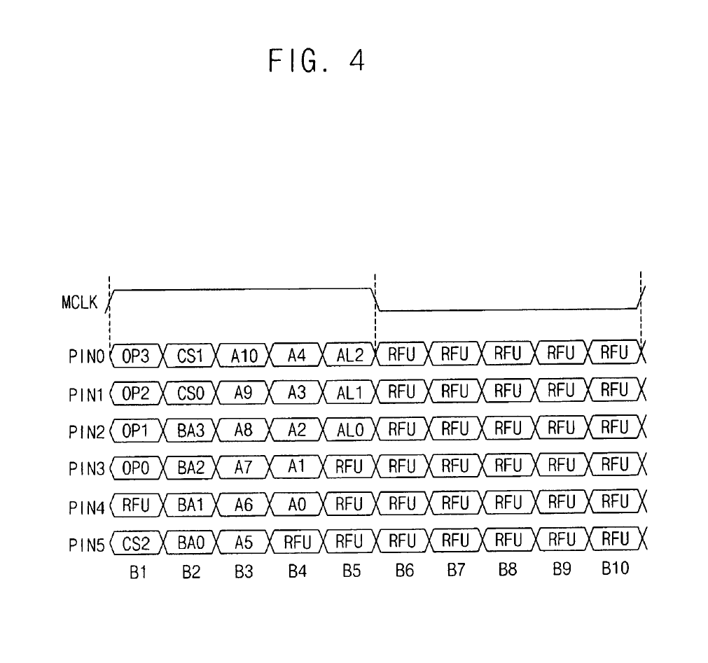

FIG. 4 is a diagram illustrating an example embodiment of a C/A packet.

Referring to FIG. 4, a C/A packet may have a size of 6 bits and 10 bursts. Thus, 60 bits of data may constitute one unit packet. 0P0 through 0P3 in the first column represent operation command fields and may provide command combinations of the memory device 200. 4-bit command fields may provide 16 command combinations. For example, each of the 4-bit command fields represents one of the generic commands for double data rate (DDR) synchronous dynamic random-access memory (SDRAM), such as ACT, READ, WRITE, READ & APC, WRITE & APC, REF, ARF, SRF, PDM, MRS and NOP. CS0 through CS2 in the first and the second columns represent rank fields. 3-bit rank fields may be directed to select a rank of the memory module and may provide at most 8 levels of rank selection codes RANK0 through RANK7. BA0 through BA3 in the second column represent bank address fields and at most 16 banks may be assigned to the bank address fields. AL0 through AL2 in the fifth column represent additive latency fields. 3-bit additive latency fields may provide additive latency codes for advancing read commands by 0 through 7 clocks within a row access strobe to column access strobe (RAS-to-CAS) delay time. AO through A10 in the third and fourth columns may be provided as row addresses and column addresses. Areas marked as “RFU” may be provided for future use, for example, as reserved areas or data areas. Therefore, the additive latency of each of the banks may be controlled by changing the additive latency code included in the active command packet at every active state.

The WD packet transmitted through the downloading bus 104 may have a size of 6 bits and 10 bursts, which may be the same size as the C/A packet. Even though the RD packet transmitted through the uploading bus 106 may have a fixed size of 10 bursts, a number of bits may be variously determined by changing a number of the bus lines.

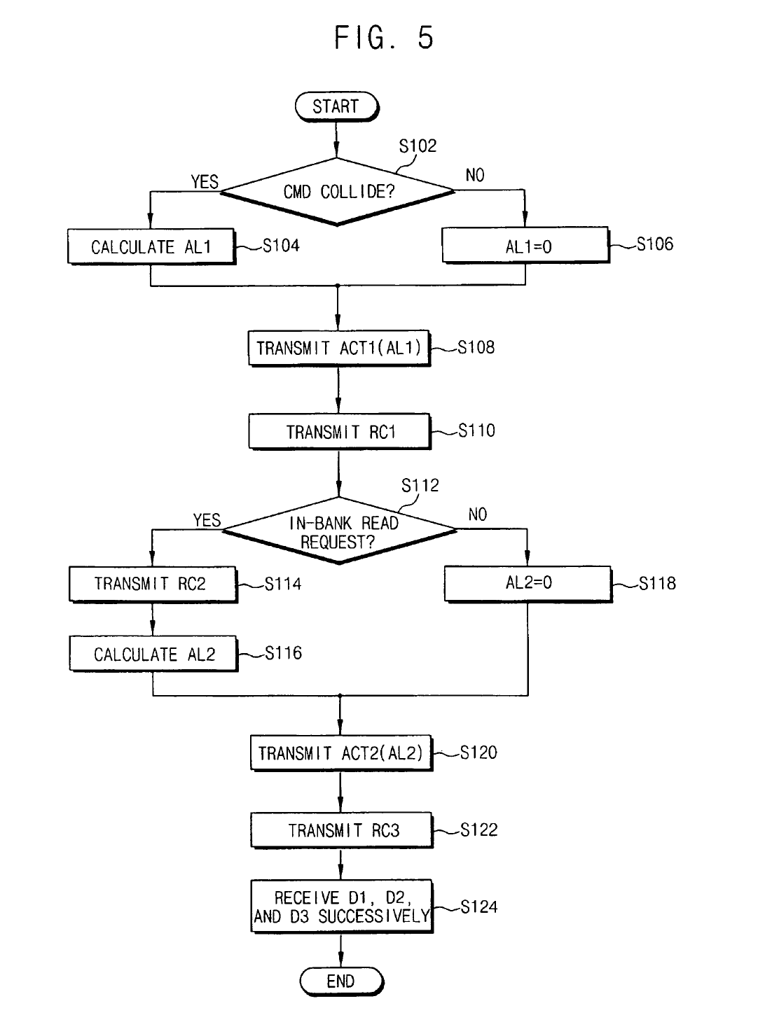

FIG. 5 is a flow chart illustrating the operation of a memory controller according to an example embodiment of the present invention.

Referring to FIG. 5, a memory controller 100 may check for a collision of commands (Step S102). For example, in DDR SDRAM, one command may be executed at one clock, but two commands may not be executed at one clock. The memory controller 100 may check for a collision of a read command RC1, which may be executed after the present active command ACT1, and an active command ACT2 that may follow.

If commands are expected to collide, the present additive latency AL1 is calculated so as to avoid a collision (Step S104). For example, a read command may be generated earlier, and an additive latency may be calculated to inform how much earlier the read command is generated. The additive latency AL1 may be calculated by any well known algorithm known to those of ordinary skill in the art.

If commands are not expected to collide, the present additive latency AL1 may be calculated as “0”, e.g., a basic value (Step S106).

An active command packet ACT1 including the calculated additive latency AL1 generated as a code in Operation S104 or Operation S106 may be transmitted to the memory device 200 (Step S108). The present read command RC1 may be generated as early as the calculated additive latency AL1 from a time point when the commands collide, and may be transmitted to the memory device 200 (Step S110).

The memory controller 100 may check for an in-bank read request to the bank BANK1 activated by the present active command ACT1 (Step S112). If the read request exists in Step S112, an in-bank read command RC2 packet may be generated to be as early as the calculated additive latency AL1 so that second data D2 may be received seamlessly following first data D1 received by the read command RC1. For example, RC1 and RC2 may be generated to be as early as AL1 with respect to the activated bank BANK1. The in-bank read command RC2 may be transmitted to the memory device 200 (Step S114).

The memory controller 100 may calculate a second additive latency AL2 so that third data D3 may be received, seamlessly following the second data D2 received by the in-bank read command RC2 (Step S116). If the in-bank read request does not exist in Step S112, the memory controller 100 may calculate the second additive latency AL2 as “0”, e.g., a basic value (Step S118).

The memory controller 100 may transmit the second active command packet ACT2 including the second additive latency AL2 generated in Operation S116 or Operation S118 as a code (Step S120). The memory controller 100 may generate a third read command packet RC3 after a RAS-to-CAS delay time, and the memory controller 100 may transmit the third read command packet RC3 to the memory device 200 (Step S122). The memory controller 100 may receive the first through the third data D1 through D3 successively from the memory device 200 after a column latency (CL) of the first read command RC1 (Step S124).

According to an example embodiment, the memory controller 100 may include a recording medium that may store program code for controlling the memory device 200. The program code may instruct the memory controller 100 to execute the steps illustrated in FIG. 5.

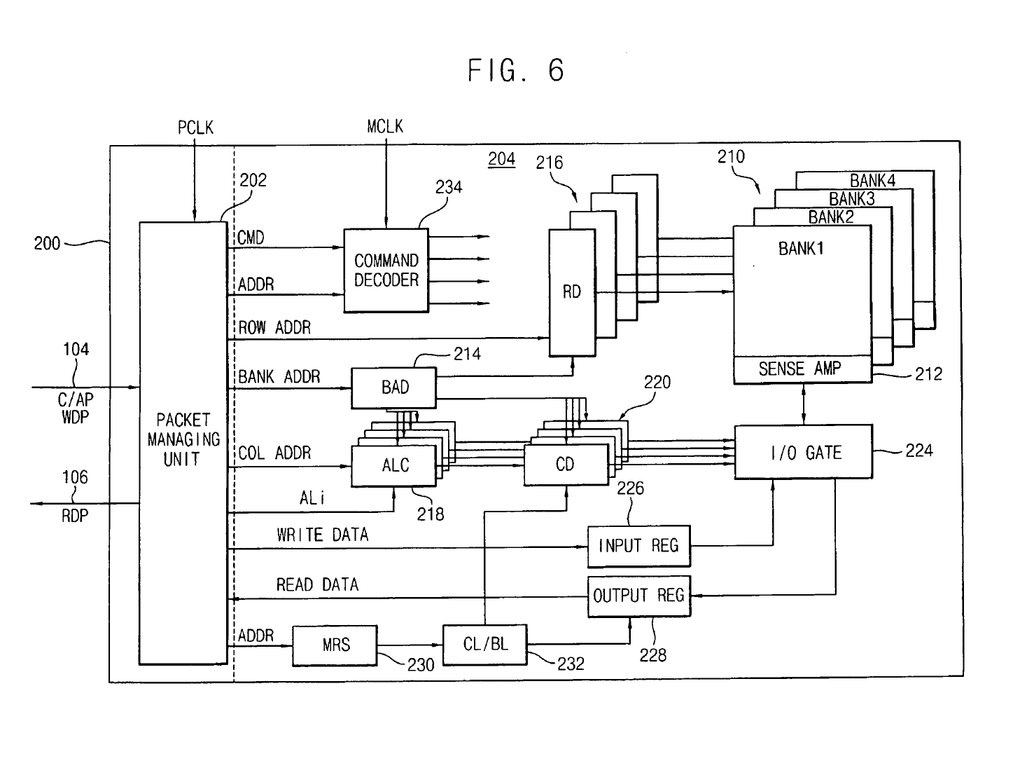

FIG. 6 is a block diagram illustrating a memory device according to an example embodiment of the present invention.

Referring to FIG. 6, a memory device 200 may include a packet managing unit 202 and a memory unit 204. The packet managing unit 202 may be connected to the memory controller 100 via a downloading bus 104 and an uploading bus 106. The packet managing unit 202 may receive a C/A packet and a WD packet, and may transmit an RD packet. The packet managing unit 202 may multiplex the downloaded packets by units of a column, and then may transmit a command, a bank address, a row address, a column address, an additive latency control signal, write data, and/or etc., to the memory unit 204. The packet managing unit 202 may demultiplex data read from the memory unit 204, and may generate read data packets.

The memory unit 204 may have a DDR synchronous multi-bank memory architecture. For example, the memory unit 204 may include a multi-bank memory block 210, a sense-amplifying block 212, a bank decoder 214, a row decoder 216, an additive latency control unit 218, a column decoder 220, an input/output (I/O) gate 224, an input data register 226, an output data register 228, a mode register 230, a column latency/burst length control unit 232, and/or a command decoder 234.

The command decoder 234 may receive a command CMD and/or an address ADDR from the packet managing unit 202 to generate control signals for controlling each unit in synchronization with a memory clock signal MCLK.

The bank decoder 214 may receive a bank address BANK ADDR to generate a bank control signal for activating a selected bank. The generated bank control signal may be provided to the row decoder 216, the additive latency control unit 218 and/or the column decoder 220. The row decoder 216 may receive a row address ROW ADDR to activate a selected wordline of the memory block 210.

A column address COL ADDR may be provided to the column decoder 220 via the additive latency control unit 218. Therefore, the column address COL ADDR may be delayed by a clock interval of the additive latency when passing the additive latency control unit 218, and may be provided to the column decoder 220.

The additive latency control unit 218 may reset a delay clock interval at every active state in response to an additive latency control signal AL1 provided from the packet managing unit 202. If the additive latency code corresponds to “0”, the column address COL ADDR may be provided to the column decoder 220 without delay. If the additive latency code corresponds to “3”, the column address COL ADDR may be provided to the column decoder 220 after a three-clock delay.

The I/O gate 224 may include logic circuits, for example, a column gate array, a read data latch, a write driver, a prefetch circuit, a data line multiplexer, and/or etc. The I/O gate 224 may select a specified column of each bank in response to a decoding signal of the column decoder 220. In a write operation mode, the I/O gate 224 may provide write data from the input register 226 to the sense-amplifying block 212. In a read operation mode, the I/O gate 224 may provide read data from the sense-amplifying block 212 to the output data register 228.

The mode register 230 may store addresses and may provide the stored mode register set value to the column latency/burst length control unit 232. The column latency/burst length control unit 232 may provide a column latency control signal and/or a burst length control signal based on the mode register set value to the column decoder 220 to control the column latency/burst length.

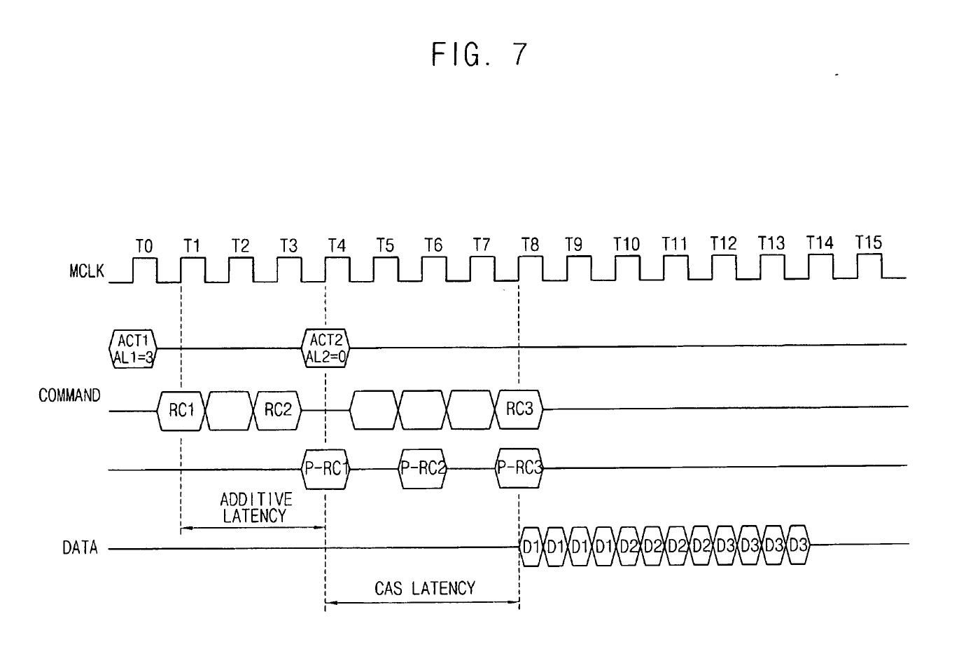

FIG. 7 is a timing diagram illustrating the operation of the memory device shown in FIG. 6. For example, tRCD may be set to a four-clock interval, the column latency may be set to a four-clock interval, and the burst length may be set to 4.

Referring to FIG. 7, the packet managing unit 202 may receive the active command and the address packet. The packet managing unit 202 may generate the active command ACT1 at T0 to provide the active command ACT1 to the memory unit 204. The command decoder 234 may generate an active control signal in response to the memory clock signal MCLK. The packet managing unit 202 may provide the bank address BANK ADDR to the bank decoder 214 and the row address ROW ADDR to the row decoder 216. The packet managing unit 202 may provide the first additive latency control signal AL1 to the additive latency control unit 218 to set the additive latency control unit 218 to a three-clock delay state.

The packet managing unit 202 may receive the read command and the address packet after one clock, and may generate a first read command RC1 at T1 and may provide the first read command RC1 to the memory unit 204. The column address COL ADDR provided from the packet managing unit 202 may be latched by the additive latency control unit 218 corresponding to the BANK1, and may be provided to the column decoder 220 after a three-clock delay.

The packet managing unit 202 may receive the in-bank read command and the address packet and may generate the second read command RC2, e.g., an in-BANK1 read command at T3, and may provide the second read command RC2 to the memory unit 204. The column address for a read operation of BANK1, provided from the packet managing unit 202, may be latched by the additive latency control unit 218 corresponding to BANK1, and may be provided to the column decoder 220 after a three-clock delay.

The packet managing unit 202 may receive the active command and the address packet, and may generate the second active command ACT2 at T4 and may provide the second active command ACT2 to the memory unit 204. The packet managing unit 202 may provide the bank address BANK ADDR to the bank decoder 214 and may provide the row address ROW ADDR to the row decoder 216. The packet managing unit 202 may provide the second additive latency control signal AL2 to the additive latency control unit 218 corresponding to BANK2, and may set the additive latency control unit 218 to a zero-clock delay state.

At T4, after a three-clock delay from T1, a column address corresponding to the first read command RC1 may be provided to the column decoder 220, and a first posted read operation P-RC1 may be executed.

At T6, after a two-clock delay from T4, a column address corresponding to the second read command RC2 may be provided to the column decoder 220, and a second posted read operation P-RC2 may be executed.

At T8, the packet managing unit 202 may provide a third read command RC3 to the memory unit 204. A column address to the BANK2 may be provided to the column decoder 220 without delay through the additive latency control unit 218 that is set to a zero-clock delay state, and a third posted read operation P-RC3 may be executed with a delay with respect to the third read command RC3.

In addition, at T8, after a four-clock column latency of BANK1, first data D1 having a burst length of 4 may be output. At T10, second data D2 following the first data D1 may be output, and at T12, third data D3 following the second data D2 may be output.

As illustrated in FIG. 7, the first through three data D1 through D3 may be output successively and seamlessly. In addition, because the additive latency is reset at every active operation without the MRS operation, a time margin for changing the additive latency may be sufficiently secured.

As described above, the memory system for controlling the multi-bank memory device according to an example embodiment of the present invention may increase operation speed by eliminating MRS access time, because the additive latency may be changed at every active command execution to avoid setting of the additive latency in advance by an MRS command. In addition, the memory system may be easily designed since a command queue may be controlled through a first in, first out (FIFO) method by controlling the additive latency.

While the example embodiments of the present invention and their advantages have been described in detail, it should be understood that various changes, substitutions and alterations may be made herein without departing from the scope.

What is claimed is:

1. A memory system comprising:
a memory device including at least a first bank and a second bank; and
a memory controller including a read request scheduling queue that stores a read request, the memory controller configured to control the read request scheduling queue so that if a first and a second read request to the first bank and a third read request to the second bank occur successively, data from the memory device is output seamlessly by applying a first additive latency to first and second read requests to the first bank, and by applying a second additive latency to a third read request to the second bank.

2. The memory system of claim 1, wherein the first and the second additive latencies are different from each other.

3. The memory system of claim 1, wherein the data is maintained in an output sequence order according to a sequence order of a plurality of read requests to a same one of the at least first and second banks.

4. The memory system of claim 1, wherein the memory controller is configured to determine if the first read request is going to collide with a second active command packet.

5. The memory system of claim 4, wherein if the first read request is going to collide with a second active command packet, the memory controller is configured to transmit a first active command packet to the memory device to set the first additive latency.

6. The memory system of claim 1, wherein the memory controller is configured to determine if there is an in-bank read request to the first bank.

7. The memory system of claim 6, wherein if there is an in-bank read request to the first bank, the memory controller is configured to transmit a second active command packet to the memory device to set the second additive latency.

8. A memory device, comprising:
a packet managing unit configured to receive a command/address (C/A) packet and a write data packet and configured to transmit a read data packet;
a multi-bank memory block;
a sense-amplifying block configured to sense-amplify input/output cell data;
a bank decoder configured to select a bank of the multi-bank memory block in response to a bank address provided from the packet managing unit;
a row decoder configured to select a wordline of the multi-bank memory block in response to a row address provided from the packet managing unit;
a column address buffer configured to latch a column address provided from the packet managing unit;
at least one additive latency block configured to delay the column address provided from the column address buffer by a clock interval in response to the additive latency code provided from the packet managing unit;
a column decoder configured to select a column of the sense-amplifying block in response to a column address provided from the additive latency block;
a data output path block configured to output read data provided from the sense-amplifying block to the packet managing unit;
a data input path block configured to provide input data provided from the packet managing unit to the sense-amplifying block; and
a command decoder configured to generate control signals in response to a command provided from the packet managing unit.

9. The memory device of claim 8, wherein the at least one additive latency block is a plurality of additive latency blocks, and wherein the plurality of additive latency blocks are configured to input an additive latency code provided from the packet managing unit in response to a selection signal of the bank decoder.

10. A memory system comprising:
a memory controller configured to transmit an active command packet including an additive latency code and transmit at least one of a read command packet and a write command packet, and
a memory device configured to receive the active command packet, reset an additive latency to the value specified by the additive latency code included in the active command packet, receive the at least one of the read command packet and write command packet, and execute the at least one of the read command packet and write command packet after a clock interval delay specified by the reset additive latency.

11. A method of controlling a memory system, the memory system including at least a memory device having at least a first bank and a second bank, and a memory controller, the memory controller including a read request scheduling queue that stores a read request, the method comprising:
controlling the read request scheduling queue so that if a first read request and a second read request to the first bank and a third read request to the second bank occur successively, data from the memory device is output seamlessly by applying a first additive latency to first and second read requests to the first bank, and by applying a second additive latency to a third read request to the second bank.

12. The method of claim 11, wherein the first and the second additive latencies are different from each other.

13. The method of claim 11, wherein the data is maintained in an output sequence order according to a sequence order of a plurality of read requests to a same one of the at least first and second banks.

14. The method of claim 11, wherein it is determined if the first read request is going to collide with a second active command packet.

15. The method of claim 14, wherein if the first read request is going to collide with a second active command packet, a first active command packet is transmitted to the memory device to set the first additive latency.

16. The method of claim 11, wherein it is determined if there is an in-bank read request to the first bank.

17. The method of claim 16, wherein if there is an in-bank read request to the first bank, a second active command packet is transmitted to the memory device to set the second additive latency.

18. A method of controlling a multi-bank memory device, comprising:
transmitting an active command packet having an additive latency code to the memory device so that a corresponding bank of the memory device has constant latency during an active state of the corresponding bank;
transmitting a first read command packet to the memory device during a row-to-column delay of the memory device;
transmitting a second read command packet to the memory device during the row-to-column delay of the memory device; and
receiving first and second read data from the memory device in response to the first and the second read command packets.

19. A method of operating a multi-bank memory device, comprising:
inputting a first active command that activates a first bank of the memory device and includes a first additive latency setting code to set an additive latency of the first bank in response to the first additive latency setting code;
inputting a first read command with respect to the first bank;
inputting a second read command with respect to the first bank;
inputting a second active command that activates a second bank of the memory device and includes a second additive latency setting code to set an additive latency of the second bank in response to the second additive latency setting code;
executing the first read command in response to the set additive latency simultaneously with the inputting of the second active command;
executing the second read command in response to the first set additive latency;
inputting a third read command with respect to the second bank to execute the third read command in response to the first set additive latency; and
outputting data according to an execution sequence of the first through the third read commands seamlessly.

20. A method of controlling a multi-bank memory device comprising,
resetting an additive latency of each bank of the multi-bank memory device at every active period of each of the banks so that each of the banks has constant additive latency during an active state of the corresponding bank.

21. The method of claim 20, wherein the additive latency of each of the banks is reset by an additive latency code included in an active command packet.

22. The method of claim 20, wherein the reset additive latency is equally applied to read commands which are different from each other during the active period.

23. A recording medium storing program code for controlling a memory device comprising:
a first program code segment causing an active command packet having an additive latency code to be transmitted to the memory device so that a corresponding bank has constant latency during an active state of the corresponding bank;
a second program code segment causing a first read command packet to be transmitted to the memory device during a row-to-column delay of the memory device;
a third program code segment causing a second read command packet to be transmitted to the memory device during the row-to-column delay of the memory device; and
a fourth program code segment causing first and second read data to be read from the memory device in response to the first and the second read command packets.
